(19) United States
(12) Patent Application Publication
(10) Pub. No.: US 2025/0131853 A1
(43) Pub. Date: Apr. 24, 2025

(54) SYSTEM AND METHOD FOR AIRWAY MANAGEMENT TRAINING USING SMART MANIKINS, AUGMENTED REALITY AND ADAPTIVE LEARNING

(71) Applicant: MEDTRAINAI TECHNOLOGIES PRIVATE LIMITED, Kolkata (IN)

(72) Inventor: Nilabhra BANERJEE, Kolkata, West Bengal (IN)

(21) Appl. No.: 18/906,573

(22) Filed: Oct. 4, 2024

(30) Foreign Application Priority Data
Oct. 19, 2023 (IN) 202331071327

(51) Int. Cl. G09B 23/28; G06F 3/01; G06N 3/044; G09B 23/30

(52) U.S. Cl. CPC G09B 23/288; G06F 3/011; G06N 3/044; G09B 23/30

(57) ABSTRACT

The present invention provides a system for Airway Management training for healthcare professionals comprising a manikin having a head, a trachea, an esophagus, a pair of lungs and a stomach. The manikin also has endotracheal implements and is operatively connected to a family of sensors at one end and to an electronic controller device at the other end. The controller device is connected to a cloud server and a graphic user interface is connected to the system. The system has an Artificial Intelligence module, for processing the data collected by the controller device and sent to the cloud server instantaneously. The Artificial Intelligence module is for deriving relevant and useful insights as well as for personalizing the feedback and generating an Augmented reality effect in the user's Graphic Interface. This module is optimally distributed over the cloud server and the controller device.

### CROSS REFERENCE TO RELATED APPLICATIONS

The present application claims the benefit of and priority to Indian Patent Application number 202331071327, filed Oct. 19, 2023, the entire contents of which is hereby incorporated by reference in its entirety.

### FIELD OF THE INVENTION

The present invention in general relates to airway management training for healthcare professionals.

More particularly, the present invention relates to a system having a cyber-physical device in the form of a smart manikin, that provides state-of-the-art, comprehensive learning experience based on instant visualization of the happenings inside the physical device (i.e., manikin), data-driven training guidance and an automated and personalized assessment module.

The present invention also embraces the methodology applying the smart the smart manikin according to the present invention.

The present complete specification is being filed in pursuance to the provisional specification filed in respect of application No. 202331071327 filed on 19th October 2023, whole of which should be considered as a part of the present complete specification.

### TECHNICAL BACKGROUND OF THE INVENTION

It is known that manikins offer reasonably good alternatives for human patients due to safety concerns. However, they do not solve the problem of lack of self-paced, self-directed and self-assessed learning, particularly for those situations where access to human trainers is rare or prohibitively expensive.

Hence Smart Manikins or cyber-physical devices are needed, as opposed to simple physical devices so that it can generate instant feed-backs for the trainee and an opportunity to self-direct the learning. In that view of the matter, web-based connected systems so that training session may be monitored by remote trainers, live or recorded.

For example, a healthcare trainee, while practicing endo-tracheal insertion on a manikin, experience significant moments of truth when the procedure goes off ideal trajectory. Some of the key moments are inadequate head tilt causing misalignment of the body axis; inappropriate tube navigation like erroneous insertion of the tube into esophagus (digestive canal) instead of trachea (i.e., windpipe); incorrect inflation of the balloon that is located at the tip of the endo-tracheal tube; and even excessive pressure on front tooth leading to tooth breakage.

The existing manikins, in general, are not smart enough to sense those significant moments during the training procedure, due to lack of insight into the happenings inside the manikin and report them outside, for immediate corrective action.

Some manikins may detect basic errors like potential tooth breakage via pressure sensors and raise alarms, but none of the existing solutions cover the spectrum of significant training moments comprehensively, correlate the training-session-specific data with user profile, manikin usage history and pool performance for the purpose of generating adaptive feed-backs, that are instant, relevant and useful.

The lack of that device smartness prevents them from providing more useful training guidance or even suggest corrective actions like preventative maintenance, need for repair or even replacement.

It is known that Virtual Reality solution have been protected by patent however that requires special glasses (e.g., Google glasses) for visualization. Also, it focuses more on setting up an alternative, digital reality as opposed to an immersive, haptic experience on an existing cyber-physical device. Also, the need for special glasses make the solution not-so-useful since such glasses are not readily available.

Manikin configuration solution, with focus on adjustability of airway passage is also known however, it has no support for audio-visual display and guidance for learning purpose.

In the above context, “Smart Manikin” features like sensor-based collection of data during training session, Internet-of-Things connectivity and basic display of collected data are known. However, in essence, they lack the underlying Artificial Intelligence capability that is necessary for real-time event orchestration and dynamic learning pathways, specific to that training situation.

The present invention proposes to solve the above drawbacks by virtue of a system having a cyber-physical device in the form of a smart manikin which is adapted to sense and capture the significant moments happening inside the manikin during the training, and render it on an Audio-Visual display outside, for instant feedback and guidance on corrective actions in that specific situation.

The present invention also embraces the methodology for the same as well, which applies the smart manikin according to the present invention.

### Objectives of the Invention

The principal objective of the present invention is to provide a system having a cyber-physical device in the form of a smart manikin and a methodology applying the manikin to sense and capture the significant moments happening inside the manikin during the training, and render it on an Audio-Visual display outside, for instant feedback and guidance on corrective actions in that specific situation.

It is another important objective of the present invention to provide a system having a cyber-physical device in the form of a smart manikin and a methodology applying the manikin which implements effective and scalable training for health-care professionals, intending to learn endo-tracheal intubation hands-on.

It is a further objective of the present invention to provide a system having a cyber-physical device in the form of a smart manikin and a methodology applying the manikin for appropriate real-time guidance based on the data collected by the sensors attached to the manikin, and the historical data on the past manikin usage.

Yet a further objective of the present invention is to ensure that the overall cyber-physical system is capable of being available over the world wide web, so that a remote instructor can visualize a live training session, watch a past recording and monitor the student's assessment anytime-anywhere (for a smart-phone).

How the foregoing objectives are achieved will be clear from the following description. In this context it is clarified that the description provided is non-limiting and is only by way of explanation.

### SUMMARY OF THE INVENTION

Accordingly, the present invention provides a system for Airway Management training for healthcare professionals comprising a manikin having a head, a trachea, an esophagus, a pair of lungs and a stomach, wherein said manikin also has endotracheal implements and wherein said manikin is operatively connected to a family of sensors at one end and to an electronic controller device at the other end, said controller device is connected to a cloud server and a graphic user interface is connected to the system and there is provided an Artificial Intelligence module, for processing the data collected by the controller device and sent to the cloud server instantaneously and for deriving relevant and useful insights as well as for personalizing the feedback and generating an Augmented reality effect in the user's Graphic Interface, said module being optimally distributed over the cloud server and the controller device.

In accordance with preferred embodiments of the system:
the endotracheal elements comprise a Laryngoscope and an Endo-Tracheal Tube fitted with a small magnet at its tip;
the family of sensors comprise:
Head Tilt Detector (Accelerometer) (2a) fixed on the head to detect the head-tilt;
Front Tooth Pressure Sensor (Force sensor) (2b) fixed near the tooth to detect excessive pressure;
Oesophageal Entry Detector (Hall Magnetic) (2c) fixed on the outer wall of the digestive canal component of the manikin;
Tracheal Force Strip Sensor (2d) fixed on the outer wall of the trachea of the manikin fixed on the outer wall of Trachea near most to esophago-tracheal junction;
a first tracheal Hall Magnetic Sensor (2e) fixed on the outer wall of Trachea near most to esophago-tracheal junction;
a second tracheal Hall Magnetic Sensor (2f) fixed on the outer wall of Trachea near esophago-tracheal junction;
a third tracheal Hall Magnetic Sensor (2g) fixed on the outer wall of Trachea near carina (i.e., bronchial bifurcation);
a fourth tracheal Hall Magnetic Sensor (2h) fixed on the outer wall of Trachea, near most to carina;
Left Lung Inflation Detector (Barometric Pressure Sensor) (2i) fixed on the inner surface of the left lung, to detect inflation; Right lung Inflation Detector (Barometric Pressure Sensor) (2j).
one or more display devices are operatively connected to the Graphic User Interface which is applied by the user to log on to the cloud server and for visualizing the results of the training;
endo-tracheal tube tip is fitted with a small, cylindrical and hollow Neodymium magnet, fixed on the inner wall of the endo-tracheal tube, close to the tip;
the Artificial Intelligence module is adapted to provide adaptive guidance and training assessment, specific to the situation, user and manikin, at any given point of time;
Artificial Intelligence module is adapted to ensure accurate calculation of the position of the endo-tracheal tube inside the manikin, based on triangulation of data from multiple, manikin-embedded sensors and helps in identification of signature moments like entry into esophagus instead of trachea and personalization of learning recommendation for the user;
the controller device is wired to the sensors via DB25-pin connector whereby it samples the sensor-collected data at the default frequency of 500 milli-seconds with the option to modify it via software interface and said device thereby orchestrates the streams of data coming from different sources and sends the output data to the cloud server almost immediately, via local wireless network connectivity to the Net;
the controller is essentially comprised of a central processor (e.g., Raspberry PI), Analog to Digital (ADC) converters, multiplexers, resistors and transistors;
a deterministic module is hosted on the Internet cloud for processing the training-session data to determine the exact position of the magnetic tube-tip inside the manikin;
there is an augmented reality module that displays the happenings inside the manikin on an external monitor;
the artificial Intelligence module is adapted to summarize the session performance and provide debriefing insights to trainee practitioners, along with personalized recommendations for improvement, said module being trained on the data of past training sessions with a clear labelling of the sessions in five categories-very good, good, OK, bad and very bad;
the deterministic module, augmented reality module and artificial intelligence module are hosted in a cloud-hosted platform that controls the entire operation and related activities like online registration of individual manikins, coordination of multiple training sessions, training session management, display of live training sessions, and replay of recorded trainings;

The present invention also provides a method for Airway Management training for healthcare professionals applying the system as described hereinbefore comprising:
a) passing the tube fitted with magnet through the body of the manikin by the trainee;
b) collecting of data by the sensors on change in magnetic flux, barometric pressure, force and acceleration;
c) sending the collected information to the controller over a wired connection;
d) sending the collected data across the Web by the Controller to the cloud server immediately;
e) processing the data by the Artificial Intelligence module for accurate calculation of the position of the endo-tracheal tube inside the manikin, based on triangulation of data from multiple, manikin-embedded sensors, whereby identification of signature moments like entry into esophagus instead of trachea and personalization of learning recommendation for the user is ensured, said user being logged on to the cloud server applying the graphic user interface which also embraces display device for input by the trainee and display of the results.

Preferably, the trainer may be located remotely may also log in the cloud server and view the progress real-time.

More preferably, the trainee chooses a follow-up training module for automated assessment said module being adaptive and generates assessment questions based on the individual training needs and also leverages Generative AI application programming interfaces (e.g., ChatGPT API) to tap into the wider body of intubation knowledge on the Net.

Even more preferably, a deterministic module that is hosted on the Internet cloud and processes the training-session data to determine the exact position of the magnetic tube-tip inside the manikin based on multiple parameters like head-tilt measurement from accelerometers, lung-pressure measurement from barometric sensors, magnetic-field measurement by Hall sensors and the spatial and temporal proximity of the sensor readings inside the manikin.

Most preferably, an augmented reality module displays the happenings inside the manikin on the display device that includes displaying and announcing the significant moments of training on the screen and raising alerts in case of an error.

The Artificial Intelligence module summarizes the session performance and provides debriefing insights to trainee practitioners, along with personalized recommendations for improvement based on being trained on the data of past training sessions with a clear labelling of the sessions in five categories-very good, good, OK, bad and very bad.

Based on the neural network training that involves a large set of clearly labeled session data, an inference module is produced and this inference module is then used to classify any new training session belonging to the above categories, based on the model weightage and the statistics of the current session compared to the past ones, whereby the neural network not only produces the assessment of any new training session based on the five labelled outcomes, but also provides personalized recommendations based on the “explainable AI” features, said “explainable AI” functionality highlights those session events that have contributed maximum to negative outcomes during a training session, so that the trainee student can work on related actions for better outcomes.

The deterministic module, augmented reality module and artificial intelligence module are hosted in a cloud-hosted platform that controls the entire operation and related activities like online registration of individual manikins, coordination of multiple training sessions, training session management, display of live training sessions, and replay of recorded trainings.

### BRIEF DESCRIPTION OF THE DRAWINGS ACCOMPANYING THE COMPLETE SPECIFICATION

The nature and scope of the present invention will be better understood from the accompanying drawings, which are by way of illustration of a preferred embodiment and not by way of any sort of limitation. In the accompanying drawings:—

FIG. 1 is view of the overall system according to the present invention.

FIG. 2 is a view of the cyber physical device according to the present invention showing the family of sensors.

FIG. 3 is a view of the edge controller device with DB-25pin connector for manikin wiring.

FIGS. 4a, 4b, 4c are views of the edge controller device and the circuitry.

FIG. 5a is a view of smart visualization of Progress of the Endo-tracheal intubation procedure real time with instant feedback and guidance for Airway Management Trainee.

FIG. 5b is a view of a standard Endo-Tracheal tube without fitting.

FIG. 5c is a view of a standard Endo-Tracheal tube tip fitted with magnet.

FIG. 6 is a schematic presentation of a follow-up training assessment model according to a preferred embodiment of the present invention.

FIGS. 7a, 7b and 7c represent screen shots of a typical exemplary performance of the system.

### DETAILED DESCRIPTION OF THE INVENTION

Having described the main features of the invention above, a more detailed and non-limiting description of some preferred embodiments will be given in the following paragraphs with reference to the accompanying drawings.

The number of components shown is exemplary and not restrictive and it is within the scope of the invention to vary the shape and size of the adjustable bed as well as the number of its components, without departing from the principle of the present invention.

All through the specification including the claims, the technical terms and abbreviations are to be interpreted in the broadest sense of the respective terms, and include all similar items in the field known by other terms, as may be clear to persons skilled in art. Restriction or limitation if any referred to in the specification, is solely by way of example and understanding the present invention.

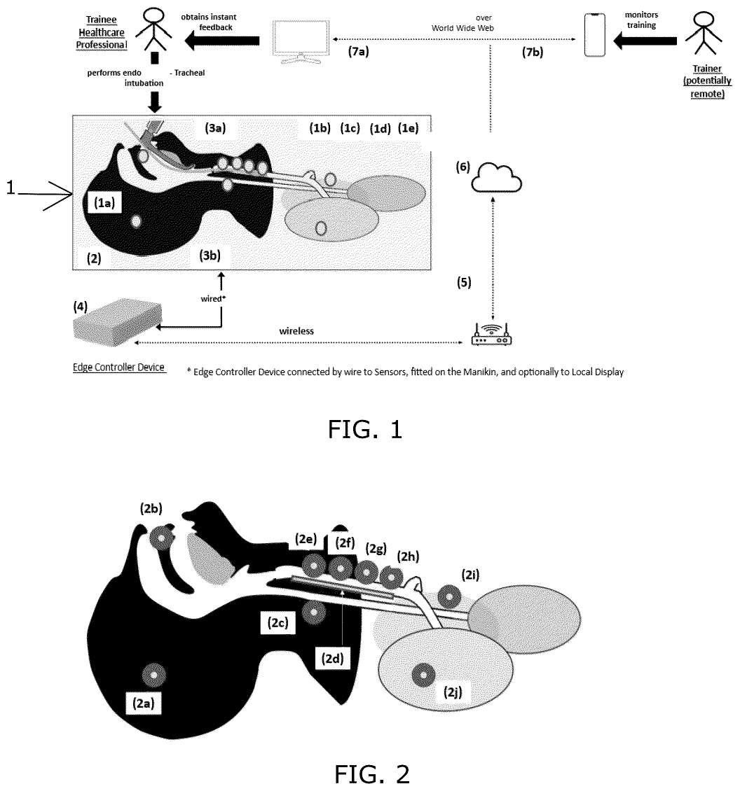

The overall working of the system is depicted in FIG. 1.

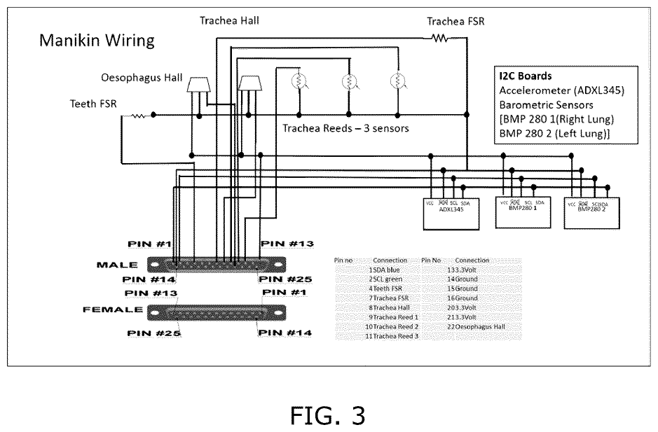

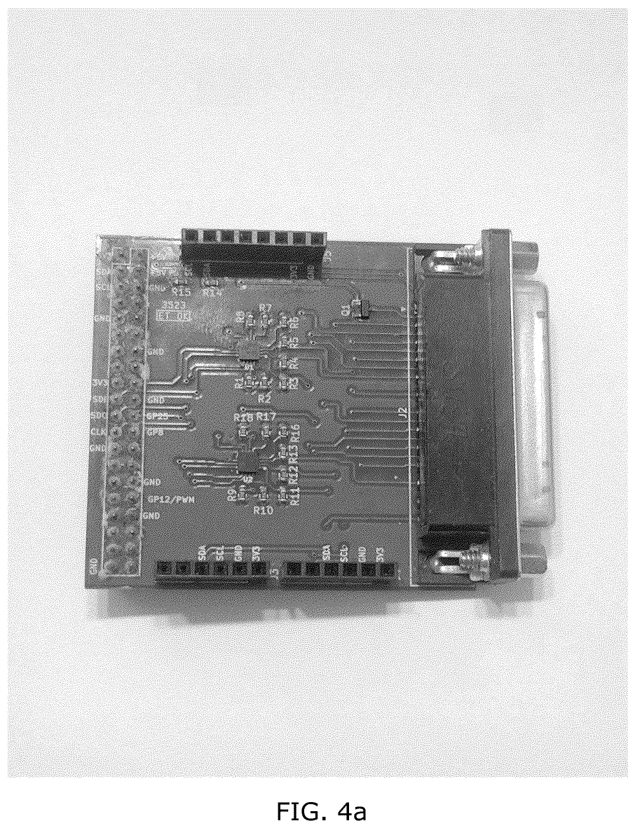

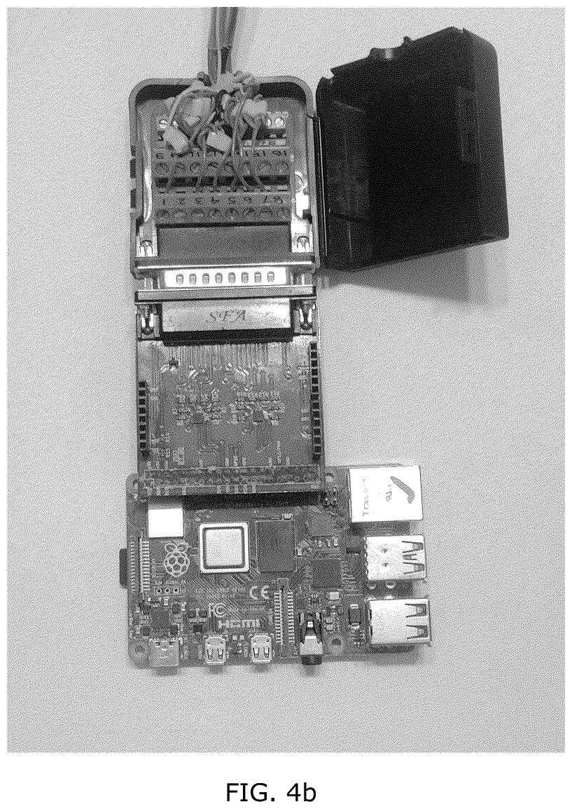

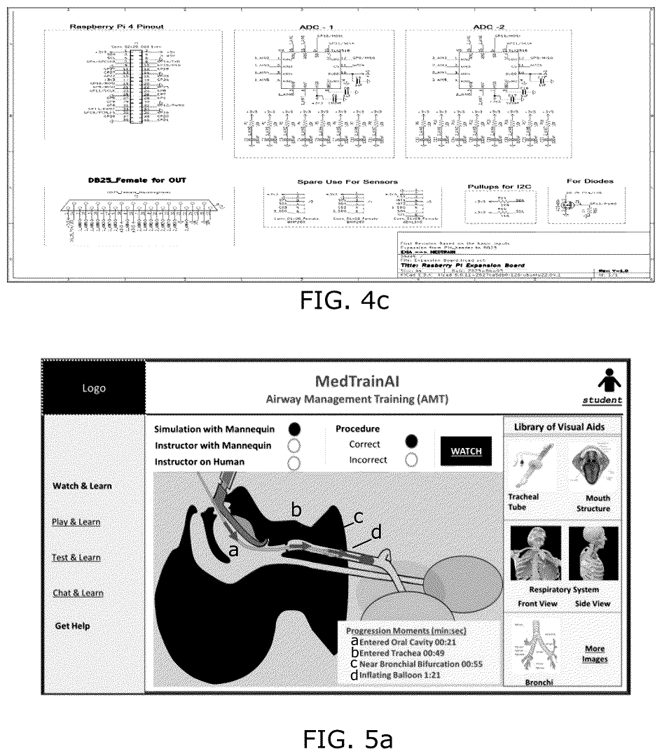

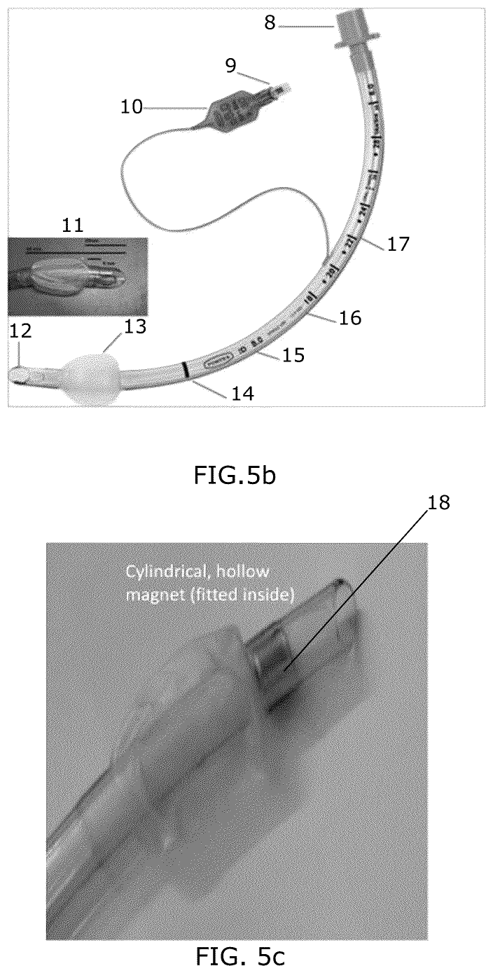

The system is essentially comprised of a cyber-physical device (i.e., a “smart” manikin), a family of sensors (FIG. 2), an endo-tracheal tube fitted with a small magnet (FIG. 5c), an electronic controller device (FIGS. 3 and 4a, 4b, 4c), a software server hosted on the Internet cloud, a web-based graphic user interface and an artificial intelligence agent that is embedded in the software of the system.

FIG. 1 in particular reflects the following:
(1) Manikin-related
   (1a) Manikin Head
   (1b) Trachea
   (1c) Esophagus
   (1d) Lungs
   (1e) Stomach
(2) Sensors
(3) Endo-Tracheal implements
   (3a) Laryngoscope
   (3b) Endo-Tracheal Tube
(4) Edge Controller Device
(5) On-premise, Wireless Router
(6) Cloud Server
(7) Display Devices
   (7a) Large Screen Local Display
   (7b) Smart Phone

FIG. 2 in particular, reflects the following sensors:
(2) Sensors
   (2a) Head Tilt Detector (Accelerometer)
   (2b) Front Tooth Pressure Sensor (Force sensor)
   (2c) Oesophageal Entry Detector (Hall Magnetic)
   (2d) Tracheal Force Strip Sensor
   (2e) Tracheal 1 Hall Magnetic Sensor
   (2f) Tracheal 2 Hall Magnetic Sensor
   (2g) Tracheal 3 Hall Magnetic Sensor
   (2h) Tracheal 4 Hall Magnetic Sensor
   (2i) Left Lung Inflation Detector (Barometric Pressure Sensor)
   (2j) Right lung Inflation Detector (Barometric Pressure Sensor)

The system is configured by converting a standard manikin (i.e., a simple physical device) into a “smart” manikin by physically attaching the family of sensors to the simple manikin on one end, and to the electronic, controller device on the other. The controller is then connected to a server on the Internet cloud via local wireless network connectivity. Finally, the user logs on to the cloud server by a graphic user interface for registration and setup completion. The manikin is now “smart” in the fact that it can sense and understand the human computer interactions and help respond accordingly.

The system leverages the principles of electro-magnetic induction for sensing the position of the endo-tracheal tube inside the manikin (FIGS. 5b, 5c). When the user inserts the endo-tracheal tube in the manikin, the sensors detect the magnetic field due to the presence of the magnet fitted at the tube tip.

FIG. 5a is a view of smart visualization of Progress of the Endo-tracheal intubation procedure real time with instant feedback and guidance for Airway Management Trainee.

FIG. 5b is a view of a standard Endo-Tracheal tube without fitting. It comprises: 15 mm connector (8), self-sealing valve (9), pilot balloon (10), tip of tube (11), bevel (12), cuff (13), level of vocal cords (14), ID internal diameter mm (15), OD outside diameter mm (16) and radio-opaque line (17).

FIG. 5c is a view of a standard Endo-Tracheal tube tip fitted with magnet (18).

As the training procedure begins, and the tube passes through the body (e.g., oral cavity, trachea), the sensors keep collecting data on change in magnetic flux, barometric pressure, force and acceleration; and keep sending the collected information to the edge controller over a wired connection.

The controller device sends the collected data across the Web to the cloud server almost immediately.

The cloud server has an Artificial Intelligence agent that processes the data, derives relevant and useful insights, personalizes the user feedback and help generate the Augmented Reality effect in the user's Graphic User Interface. The Augmented Reality effect needs artificial intelligence for accurate calculation of the position of the endo-tracheal tube inside the manikin, based on triangulation of data from multiple, manikin-embedded sensors. It also helps in identification of signature moments like entry into esophagus instead of trachea and personalization of learning recommendation for the user.

The trainer, who may be located remotely may also log in the cloud server and view the progress real-time.

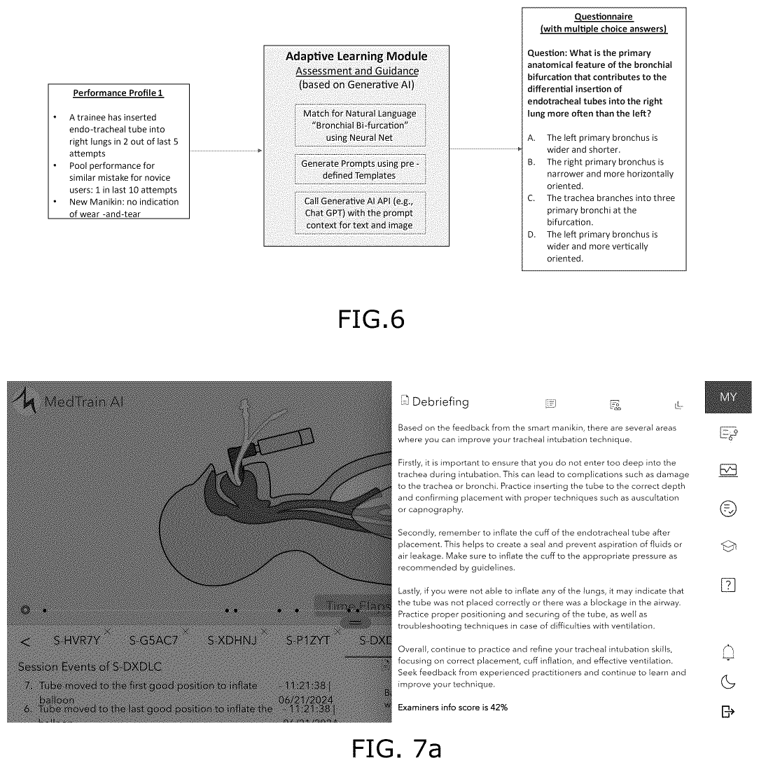

There is a follow-up training assessment model that the trainee may choose to use for automated assessment. The assessment model is adaptive and generates assessment questions based on the individual training needs. It also leverages Generative AI application programming interfaces (e.g., ChatGPT API) to tap into the wider body of intubation knowledge on the Net. The detailed module is shown in FIG. 6.

The novelty as well as technical advancement of the present invention is as follows:
The composition of an overall system that provides comprehensive, real-time feedback on the key significant moments of manikin-based endo-tracheal training (i.e., detecting appropriate head tilt for correct alignment, wrongful entry of endo-tracheal tube in esophagus as opposed to trachea, smooth journey inside the trachea, appropriate inflation of the balloon at the end of the tube tip to prevent surrounding airflow, stopping short before lungs bi-furcation, and excessive pressure on front tooth risking tooth breakage).
While prior art and some existing models cover tooth breakage feedback by clicks and other auditory alarms, this patent covers all of the above significant moments comprehensively by triangulating data from multiple sensors and mashing it up with usage history and time series analysis of the trends in manikin wear-and-tear (FIGS. 1-5a, 5b, 5c).
The capability to provide adaptive guidance and training assessment, specific to the situation, user and manikin, at any given point of time. This is accomplished by the Artificial Intelligence software agent that is optimally distributed over the cloud server and edge controller. The specific technology components and their working are specified in the foregoing.

The accessibility of the inside-manikin story to remote users anywhere, anytime because of it cloud-ready architecture (FIG. 1).

The system is an Augmented Reality system that is used for training next-generation healthcare practitioners in endo-tracheal intubation for patients who need urgent respiratory medical intervention.

The training system simulates real-life endo-tracheal intubation challenges in a human-like manikin. It is fitted with the following components:
1) A manikin that mimics the structure of a human upper body with a head, face, mouth, teeth, the oral cavity, the tongue, the respiratory tract, the digestive canal, and a pair of lungs, made of synthetic polymer and proprietary manufacturing process.
2) A endo-tracheal tube, fitted with magnetic tip that is inserted into the tracheal tube inside the manikin as part of the training procedure.
3) Sensors that are embedded in the manikin and collect data on the training session (i.e., intubation procedure) by the practitioners during the training session based on various parameters (e.g., head-tilt measuring accelerometers, lung-pressure measuring barometric sensors and magnetic-field measuring sensors that indicate the proximity of the magnetic tube-tip inside the manikin).
4) An Electronics Controller Device that is attached to the manikin and a wireless communication unit. It sends the training-session data to a software platform hosted on the Internet cloud.
5) A Deterministic module that is hosted on the Internet cloud and processes the training-session data to determine the exact position of the magnetic tube-tip inside the manikin by use of a proprietary algorithm. The algorithm pinpoints the position of the end-tracheal tube, based on multiple parameters (e.g., head-tilt measurement from accelerometers, lung-pressure measurement from barometric sensors, magnetic-field measurement by Hall sensors and the spatial and temporal proximity of the sensor readings inside the manikin).
The algorithm is based on a complex set of business rules that introspects the values of all the sensors simultaneously to figure out what is the most possible outcome given the incoming sensor-generated data at any given time, the past positions of the tube in last few seconds and the direction it was last sensed as moving to. The algorithm factors in a recency-frequency model to predict the exact position of the tip of the endo-tracheal tube, moving inside the manikin.
6) An Augmented Reality module that displays the happenings inside the manikin on an external monitor (e.g., smart phones). It lays over the internal events on the manikin picture using proprietary visualization software. The proprietary visualization software renders the position of the tube as computed by the Deterministic Software module on the manikin image in a browser window. The algorithm is unique in the sense that it detects any event regarding the tube movement instantaneously, leveraging standard Javascript libraries and frameworks for automatic rendering and repainting of the visualization layer. The solution also implements a text-to-speech software program to read-out the warnings and alerts for the trainee student who may be too engrossed in the intubation procedures to look at the visual display on the attached monitor.
7) An Artificial Intelligence (AI) module that summarizes the session performance and provides debriefing insights to trainee practitioners, along with personalized recommendations for improvement. The AI software module is based on a recurrent neural network. It is trained on the data of past training sessions with a clear labelling of the sessions in five categories-very good, good, OK, bad and very bad. Based on the neural network training that involves a large set of clearly labeled session data, an inference module is produced.
This inference module is them used to classify any new training session belonging to the above categories, based on the model weightage and the statistics of the current session compared to the past ones. The neural network not only produces the assessment of any new training session based on the five labelled outcomes, but also provides personalized recommendations based on the “explainable AI” features of this proprietary module.
The “explainable AI” functionality highlights those session events that have contributed maximum to negative outcomes during a training session, so that the trainee student can work on related actions for better outcomes.
8) There is a cloud-hosted platform that hosts the above components 5, 6 and 7 and an additional software orchestrator module that controls the entire eco-system of all operational DRISH systems and related activities (e.g., online registration of individual manikins, coordination of multiple training sessions, training session management, display of live training sessions, and replay of recorded trainings).

The methodology according to the present invention for practicing endo-tracheal intubation on the system, may be further classified according to the following nine steps:

### 1. Intubation:

The practitioner starts the process by inserting the endo-tracheal tube inside the smart manikin. The tube is fitted with a small ring magnet at the tip, so that its movement can generate electro-magnetic flux in presence of sensors placed inside the manikin. The appropriate position and calibration of the sensors inside the manikin with respect to threshold values, is done.

### 2. Sensor Data Collection:

The data generated by the sensors on detecting the movement of the magnetic-tipped endo-tracheal tube inside the manikin, along with the related temporal metadata is processed by the manikin controller box and sent to the cloud, over the generic MQTT data-transfer protocol. The sampling frequency for the sensor data and the format and sequence of data item transfer are specific to the system, produced as part of its research. The electronic circuitry of the manikin controller box for initial processing (e.g., signal processing, sampling error correction and back-end cloud communication) is designed specifically for the system. The underlying protocol for cloud access is generic “https” Internet protocol.

### 3. Location Triangulation

The data, collected by the sensors and staged in the backend cloud platform, is further processed by “Location Triangulation”, to determine the exact location of the magnetic tip inside the manikin (e.g., at the bifurcation point of the digestive and respiratory tracts; at the entry point of the right bronchus). This is done by a proximity calculation program that checks for the most probable sensor it is nearest to, based on the magnitude of the sensor value and the time journey of the magnetic tip past other sensors that are nearby. This proximity calculation is based upon physics (the closer the magnet, the higher the detection of magnetic flux); electronics (the higher the magnetic flux, the higher the sensor value); and mathematics (the higher the sensor value, the higher is the probability of the tube tip near that sensor, provided the past time window from three nearby sensors support that journey through statistical correlation).

### 4. Visualization and Co-Sharing

The most probable location of the magnetic tip of the end-tracheal tube, as processed by the proximity calculation program in the previous step, is rendered as a visual element on the graphic user interface of any display terminal that is connected to the cloud, accessible by world wide web. This rendering of the visuals is a non-trivial exercise because the module attempts to lay over one moving point (i.e., the location of the magnetic tip moving inside the manikin) on another moving image (i.e., the manikin itself who head part may be tilting during the intubation procedure). The module carefully orchestrates the two movements real-time via time warping and combines the two in a single image rendition.

### 5. Significant Event Detection and Alert Generation

As the endo-tracheal passes the sensor points and its potential location inside the manikin is detected outside in the back-end platform by the “location triangulation” module (refer Step 2), an “Event Detection” module applies a rule engine to detect the significant moments during the movement of the tube (e.g., wrong entry into digestive tract instead of respiratory tract, excessive tooth pressure). The rules of the rule engine is based on the standard operating procedure per commonly accepted protocol adopted by medical practitioners worldwide. The pertinent software code implements the rule engine itself, watching over the streaming data generated by the system for event detection real-time. The alerts are displayed as well as read out with auditoryclip accompaniment.

### 6. Session Co-sharing, Recording and Playback

A “co-sharing” module orchestrates the multiple inter-actions on different terminals (e.g., student and the remote instructor) in time-domain so that multiple viewership is enabled for the same procedure on multiple display terminals. The implementation of the co-sharing platform, orchestrating multiple interactions by viewers accessing the same session from different terminals is in accordance with the invention.

### 7. Automated Assessment and Scoring

The automated assessment (debriefing) is distinct from the manual instructor feedback. The module for automated assessment of the quality of endo-tracheal intubation is proprietary. It uses a discriminative neural network that is trained on the data generated by sensors during thousands of practice sessions and manually labelled into different classes (i.e., good, bad, excellent, or average). There is a corresponding scoring scale attached to it, the higher score representing better quality of procedure. The fully trained neural network receives data the data for any new practice session for which the user wants an automated assessment (i.e., debriefing) and neural network classifies the session data (based on it prior training). The design and implementation of the neural network, including the number of layers, nodes, choice of activation functions, fine-tuning of the network parameters and the Python source code are in accordance with the Smart manikin systems of the invention.

The assessment, consisting of the score and the debriefing statement, explains the reasons for assessment scores based on significant moments and errors during the procedure (e.g., explainable AI). The scores are based on pitfalls or incidents like too long procedures, wrong entries, lack of practitioner's confidence displayed due to dithering and too-many back—and—forth of motion of the tracheal tube.

### 8. Adaptive Cognitive Testing

Based on the assessment score generated by the automated assessment module (refer Step 7), an adaptive cognitive testing module is kicked off from the Graphic User Interface if the practitioner wills. The pitfalls like “repeated digestive tract entry” that are identified previously (refer step 7) feeds into a “prompt engineering algorithm” here. The “prompt engineering algorithm” generates context-sensitive prompt, that specific to the kind of errors made in the practice session. Subsequently, the generated prompts are passed to a Generative Large Language Model via standard application programming interfaces for generation of “questionnaires” around the errors committed during practice session. The prompt engineering that feeds the questionnaire generation process is in accordance with the present invention.

### 9. Feedback Learning

The metrics are collected during the entire process from intubation to adaptive cognitive testing and analyzed to feed into the process every few months, for process optimization. The metrics like time to intubate, session co-sharing, pass rate in the multiple-choice questions are inputs to the standard regression and clustering techniques for further insight generation like manikin device calibration, wear-and-tear analysis and usage trends.

The non-limiting salient features of the present invention are as follows:
1) Composition of a Learning System for Endo-Tracheal Intubation with real-time feedback on the position of the endo-tracheal tube inside the manikin (FIGS. 1, FIG. 5a)
2) Sensor fitment on manikins with sensor placement in signific areas of the manikin and their wiring to the controller box (FIG. 2)
3) Design of the electronic circuitry of controller box (i.e., motherboard) using standard, off-the-shelf electronic components that include Raspberry PI processor, Analog to-Digital converters, Resistors, Transistors and Multiplexers (FIGS. 3, 4a, 4b).
4) Development of Artificial Intelligence software for determining the accurate position of the endo-tracheal tube inside the manikin, based on the triangulation of data from the multiple sensors, the manikin usage history and the wear-and-tear trend analysis.
5) The form of Human Computer Interaction where the user gets to visualize the happening inside manikin using Audio Visual mode, that includes displaying and announcing the significant moments of training on the screen and raising alerts in case of an error (FIG. 5a).
6) The form of Human Computer Interaction where the manikin administrator gets to configure the manikin via the edge controller box including setting the levels of sensor threshold for processing variable configuration. For example, the threshold of barometric pressure sensor inside the lungs may be elevated for creating the illusion of fibrotic lungs (FIG. 2).
7) The Adaptive Assessment module where the user performance triggers the customized generation of assessment questionnaire using Generative AI Solutions, including the integration of ChatGPT APIs for medical training purpose.

The system is essentially comprised of the following components.
1. A cyber-physical device (i.e., a “smart” manikin) (FIG. 1)
2. An endo-tracheal tube fitted with a small magnet (FIG. 5c)
3. A family of sensors (FIG. 2)
4. An electronic controller device, referred to as edge controller (FIGS. 3 and 4a, 4b, 4c)
5. A software server hosted on the Internet cloud.
6. A web-based graphic user interface (FIG. 5a)
7. An artificial intelligence agent that is embedded in the system software as elaborated in the foregoing.

A standard manikin (i.e., a simple physical device) is converted into a “smart” manikin by physically attaching the family of sensors to the simple manikin on one end, and to the edge controller device on the other. The edge controller is connected to a server on the Internet cloud via local wireless network connectivity. Finally, the manikin becomes “smart” when the software setup for a specific user training session is complete, and ready to sense and understand the human computer interactions on it and respond accordingly. It is critical to note that the sensors provide sensing, while the artificial intelligence software on the cloud provides understanding.

The sensors and their placement on the manikin play a key role in the above setup (see FIG. 2). They are fitted on the manikin as fixed attachment on the manikin components as specified below.

Here is the list of standard sensors that are combined with the rest of the system to make the manikin “smart”. The labels are the same as in FIG. 2.
1. Label 2a: Head Tilt Detector (Accelerometer), fixed on the head to detect the head-tilt.
2. Label 2b: Front Tooth Pressure Sensor (Force sensor), fixed near the tooth to detect excessive pressure.
3. Label 2c: Oesophageal Entry Detector (Hall Magnetic), fixed on the outer wall of the digestive canal component of the manikin.
4. Label 2d: Tracheal Force Strip Sensor, fixed on the outer wall of the trachea of the manikin.
5. Label 2e: Tracheal Sensor 1 Hall Magnetic Sensor, fixed on the outer wall of Trachea near most to esophago-tracheal junction.
6. Label 2f: Tracheal Sensor 2 Hall Magnetic Sensor: fixed on the outer wall of Trachea near esophago-tracheal junction.
7. Label 2g: Tracheal Sensor 3 Hall Magnetic Sensor fixed on the outer wall of Trachea near carina (i.e., bronchial bifurcation).
8. Label 2h: Tracheal Sensor 4 Hall Magnetic Sensor, fixed on the outer wall of Trachea, near most to carina.
9. Label 2i: Left-Lung Inflation Detector, Barometric Pressure Sensor, fixed on the inner surface of the left lung, to detect inflation.
10. Label 2j: Right-Lung Inflation Detector (Barometric Pressure Sensor, fixed on the inner surface of the right lung, to detect inflation.

The endo-tracheal tube tip is fitted with a small, cylindrical and hollow Neodymium magnet, fixed on the inner wall of the endo-tracheal tube, close to the tip. This leverages the principles of electro-magnetic induction for sensing the position of the endo-tracheal tube inside the manikin (FIG. 5b, 5c). When the user inserts the endo-tracheal tube in the manikin, the sensors detect the magnetic field due to the presence of the magnet fitted at the tube tip.

As the training procedure begins, and the tube passes through the body (e.g., oral cavity or trachea) the sensors keep collecting data on change in magnetic flux, barometric pressure, force and acceleration; and keep sending the collected information to the edge controller over a wired connection. The controller device is wired to the sensors via DB25-pin connector (FIG. 3) It samples the sensor-collected data at the default frequency of 500 milli-seconds with the option to modify it via software interface. It orchestrates the streams of data coming from different sources and sends the output data to the cloud server almost immediately, via local wireless network connectivity to the Net. The circuit design of the edge controller motherboard is developed from the scratch based on the overall system need. The controller is essentially comprised of a central processor (e.g., Raspberry PI), Analog to Digital (ADC) converters, multiplexers, resistors and transistors. It is possible to modify the settings on the controller or modify its logic for up-sampling, down-sampling, change in orchestration and introduction of further local processing (e.g., on-premise peripheral intelligence).

The cloud server ingests, stores and archives the mass load of data coming from sensors from multiple manikins across the world. It processes the streaming data collected by sensors by triangulating information on voltage levels from each sensor, mashes it up with multiple windows of past moments and determines the accurate position of the endo-tracheal tube inside the manikin to detect significant moments of user training like inappropriate tube navigation.

The Augmented Reality experience on the Graphic User Interface (GUI) is primarily due to overlay of the sensor data from physical device on the cyber image of the manikin, powered by the understanding of the underlying artificial intelligence agent that makes “sense” out of sensed data.

There is a follow-up training assessment model that the trainee may choose to use for automated assessment as elaborated in the foregoing. The assessment model is adaptive and generates assessment questions based on the individual training needs. It also leverages Generative AI application programming interfaces (e.g., ChatGPT API) to tap into the wider body of intubation knowledge on the Net.

Now how the system functions will be further explained with reference to two examples:

### Example 1

This session is of 20 seconds. The person could get into trachea at the first chance (which is very good). But he went down too far into trachea to right bronchus. Then he pulled back to last good position to inflate the balloon. But he failed to inflate the balloon. He stops the session at the this point of time.

Debriefing: Based on the feedback from the smart manikin, there are several areas where you can improve your tracheal intubation technique.

Firstly, it is important to ensure that you do not enter too deep into the trachea during intubation. This can lead to complications such as damage to the trachea or bronchi. Practice inserting the tube to the correct depth and confirming placement with proper techniques such as auscultation or capnography.

Secondly, remember to inflate the cuff of the endotracheal tube after placement. This helps to create a seal and prevent aspiration of fluids or air leakage. Make sure to inflate the cuff to the appropriate pressure as recommended by guidelines.

Lastly, if you were not able to inflate any of the lungs, it may indicate that the tube was not placed correctly or there was a blockage in the airway. Practice proper positioning and securing of the tube, as well as troubleshooting techniques in case of difficulties with ventilation.

Overall, continue to practice and refine your tracheal intubation skills, focusing on correct placement, cuff inflation, and effective ventilation. Seek feedback from experienced practitioners and continue to learn and improve your technique.

### Examiners Info Score is 42%

### Session DXDLC MCQ

Test your Knowledge

What is the correct depth of insertion for a tracheal tube during intubation?
5-7 cm (Correct answer)
10-12 cm
15-17 cm
20-22 cm

When should the cuff of the tracheal tube be inflated during intubation?
Before insertion
After insertion (Correct Answer)
During insertion
Not necessary to inflate

What could be a possible reason for not being able to inflate the lungs after intubation?
Incorrect tube size
Incorrect insertion depth
Cuff not inflated (Correct Answer).
All of the above

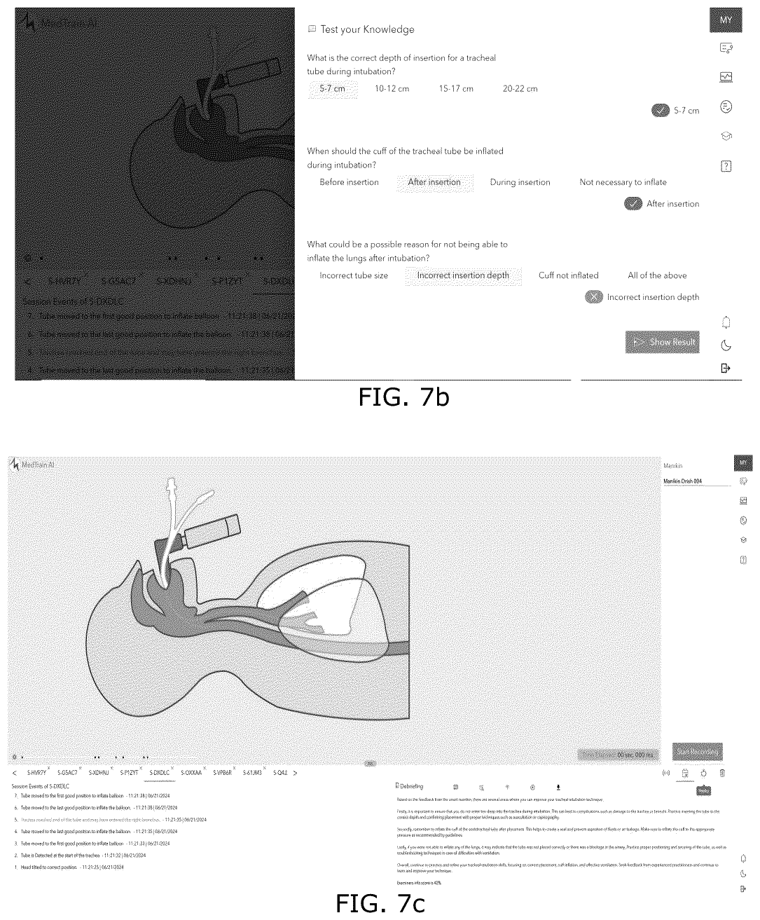

Screenshot of DXDLC Debriefing as shown in FIG. 7a.

Screenshot of DXDLC MCQ as shown in FIG. 7b.

Screenshot of DXDLC Playback as shown in FIG. 7c.

### Example 2

This session is of 37 seconds, just below time penalty threshold. The person took 6 seconds to tilt the head to correct position. The person could NOT get into trachea at the first chance, went to Oesophagus instead. But once alerted by the system, the person quickly pulled the ET tube out and put it into trachea. Rest of the job is done perfectly.

Debriefing: Based on the feedback from the smart manikin, there are a few areas where you can focus on improving your tracheal intubation technique.
1. Maintaining head tilt position: It is important to maintain the correct head tilt position throughout the intubation process to ensure proper alignment of the airway. Practice maintaining the correct head tilt position consistently during intubation simulations.
2. Avoiding wrong entry into the oesophagus: Accidentally entering the oesophagus during intubation can be dangerous and ineffective. Focus on improving your technique and ensuring proper alignment of the endotracheal tube with the trachea. Practice visualizing the correct placement of the tube before advancing it.

Overall, continue to practice and refine your tracheal intubation technique to improve your skills and avoid common mistakes. Seek feedback from experienced practitioners and continue to participate in simulations to enhance your proficiency in this critical procedure.

### Examiners Info Score is 90%

### Session S4IFJ MCQ

Test your Knowledge

What is the correct position of the head during tracheal intubation?
Neutral position.
Head tilt (Correct Answer)
Head rotation
Head flexion

What is the correct entry point for tracheal intubation?
Oesophagus
Trachea (Correct Answer)
Pharynx
Larynx
Which of the following is a common complication of tracheal intubation?
Pneumonia
Hypertension
Bradycardia
Hypoxemia (Correct Answer)

The top 3 comparison that are known to be closest to the functions and features of the system described in this patent, are presented as follows:
1. Commercially available Laerdal Airway Management Trainer
2. NASCO Airway Larry
3. Ensemble of non-branded manikins and manikin parts

Laerdal Airway Management trainer offers excellent experience to the user in terms of manikin feel-and-finish, the smooth human-like skin and haptic feedback on the physical device. The solution offers a tooth breakage click on application of excessive force during intubation.

NASCO Airway Larry offers equally pleasant experience but does not appear to have feedback features. It offers more room for structural configurability in terms of assembly at the component level.

The non-branded manikins do not generally offer superior physical device feel—and—finish. Sometimes they come equipped with a couple of sensors, primarily for detection of excessive pressure in the oral cavity.

None of the above solution are truly cyber-physical solution with comprehensive audio-visual feedback capability a.k.a. augmented reality experience, adaptive learning and dynamic assessment pathways using Generative AI and accessibility over the Web.

The invention ensures scalability of the solution for more effective hands-on training in endo-tracheal intubation.

This invention adds self-paced, self-directed, self-assessed learning capability to conventional manikin training.

With more audio-visual feedback, adaptive learning and web accessibility, this solution is extremely useful for rolling-out training in those countries and situations where access to experienced healthcare trainers is rare or prohibitively expensive.

From the above description it should be clear that all objectives of the present invention are met.

The present invention has been described with reference to some drawings and preferred embodiments purely for the sake of understanding and not by way of any limitation and the present invention includes all legitimate developments within the scope of what has been described herein before and claimed in the appended claims.

We claim:

1. A system for Airway Management training for healthcare professionals comprising: a manikin having a head, a trachea, an esophagus, a pair of lungs and a stomach, wherein said manikin further comprises endotracheal implements and wherein said manikin is operatively connected to a family of sensors at one end and to an electronic controller device at the other end, said controller device is connected to a cloud server and a graphic user interface is connected to the system and there is provided an Artificial Intelligence module, for processing the data collected by the controller device and sent to the cloud server instantaneously and for deriving relevant and useful insights as well as for personalizing the feedback and generating an Augmented reality effect in the user's Graphic Interface, said module being optimally distributed over the cloud server and the controller device.

2. The system for Airway Management training as claimed in claim 1, wherein the endotracheal elements comprise a Laryngoscope and an Endo-Tracheal Tube fitted with a small magnet at its tip.

3. The system for Airway Management training as claimed in claim 1, wherein the family of sensors comprise:
Head Tilt Detector (Accelerometer) fixed on the head to detect the head-tilt;
Front Tooth Pressure Sensor (Force sensor) fixed near the tooth to detect excessive pressure;
Oesophageal Entry Detector (Hall Magnetic) fixed on the outer wall of the digestive canal component of the manikin;
Tracheal Force Strip Sensor fixed on the outer wall of the trachea of the manikin fixed on the outer wall of Trachea near most to esophago-tracheal junction;
a first tracheal Hall Magnetic Sensor fixed on the outer wall of Trachea near most to esophago-tracheal junction;
a second tracheal Hall Magnetic Sensor fixed on the outer wall of Trachea near esophago-tracheal junction;
a third tracheal Hall Magnetic Sensor fixed on the outer wall of Trachea near carina (i.e., bronchial bifurcation);
a fourth tracheal Hall Magnetic Sensor fixed on the outer wall of Trachea, near most to carina;
Left Lung Inflation Detector (Barometric Pressure Sensor) fixed on the inner surface of the left lung, to detect inflation;
Right lung Inflation Detector (Barometric Pressure Sensor).

4. The system for Airway Management training as claimed in claim 1, wherein one or more display devices are operatively connected to the Graphic User Interface which is applied by the user to log on to the cloud server and for visualizing the results of the training.

5. The system for Airway Management training as claimed in claim 1, wherein the endo-tracheal elements have an endo-tracheal tube tip is fitted with a small, cylindrical and hollow Neodymium magnet, fixed on the inner wall of the endo-tracheal tube, close to the tip.

6. The system for Airway Management training as claimed in claim 1, wherein the Artificial Intelligence module is adapted to provide adaptive guidance and training assessment, specific to the situation, user and manikin, at any given point of time.

7. The system for Airway Management training as claimed in claim 1, wherein the Artificial Intelligence module is adapted to ensure accurate calculation of the position of the endo-tracheal tube inside the manikin, based on triangulation of data from multiple, manikin-embedded sensors and helps in identification of signature moments like entry into esophagus instead of trachea and personalization of learning recommendation for the user.

8. The system for Airway Management training as claimed in claim 1, wherein the controller device is wired to the sensors via DB25-pin connector whereby it samples the sensor-collected data at the default frequency of 500 milli-seconds with the option to modify it via software interface and said device thereby orchestrates the streams of data coming from different sources and sends the output data to the cloud server almost immediately, via local wireless network connectivity to the Net.

9. The system for Airway Management training as claimed in claim 1, wherein the controller is essentially comprised of a central processor (e.g., Raspberry PI), Analog to Digital (ADC) converters, multiplexers, resistors and transistors.

10. The system for Airway Management training as claimed in claim 1, wherein a deterministic module is hosted on the Internet cloud for processing the training-session data to determine the exact position of the magnetic tube-tip inside the manikin.

11. The system for Airway Management training as claimed in claim 1, wherein there is an augmented reality module that displays the happenings inside the manikin on an external monitor.

12. The system for Airway Management training as claimed in claim 1, wherein the artificial Intelligence module is adapted to summarize the session performance and provide debriefing insights to trainee practitioners, along with personalized recommendations for improvement, said module being trained on the data of past training sessions with a clear labelling of the sessions in five categories-very good, good, OK, bad and very bad.

13. The system for Airway Management training as claimed in claim 1, wherein a deterministic module, an augmented reality module and the artificial intelligence module are hosted in a cloud-hosted platform that controls the entire operation and related activities like online registration of individual manikins, coordination of multiple training sessions, training session management, display of live training sessions, and replay of recorded trainings.

14. A method for Airway Management training for healthcare professionals applying the system as claimed in claim 1 comprising:
a) passing an endo-tracheal tube fitted with magnet through the body of the manikin by the trainee;
b) collecting of data by the sensors on change in magnetic flux, barometric pressure, force and acceleration;
c) sending the collected information to the controller over a wired connection;
d) sending the collected data across the Web by the Controller to the cloud server immediately; and
e) processing the data by the Artificial Intelligence module for accurate calculation of the position of the endo-tracheal tube inside the manikin, based on triangulation of data from multiple, manikin-embedded sensors, whereby identification of signature moments like entry into esophagus instead of trachea and personalization of learning recommendation for the user is ensured, said user being logged on to the cloud server applying the graphic user interface which also embraces display device for input by the trainee and display of the results.

15. The method for Airway Management training for healthcare professionals as claimed in claim 14, wherein the trainer who may be located remotely may also log in the cloud server and view the progress real-time.

16. The method for Airway Management training for healthcare professionals as claimed in claim 14, wherein the trainee chooses a follow-up training module for automated assessment said module being adaptive and generates assessment questions based on the individual training needs and also leverages Generative AI application programming interfaces (e.g., ChatGPT API) to tap into the wider body of intubation knowledge on the Net.

17. The method for Airway Management training for healthcare professionals as claimed in claim 14, wherein a deterministic module that is hosted on the Internet cloud and processes the training-session data to determine the exact position of the magnetic tube-tip inside the manikin based on multiple parameters like head-tilt measurement from accelerometers, lung-pressure measurement from barometric sensors, magnetic-field measurement by Hall sensors and the spatial and temporal proximity of the sensor readings inside the manikin.

18. The method for Airway Management training for healthcare professionals as claimed in claim 14, wherein an augmented reality module displays the happenings inside the manikin on the display device that includes displaying and announcing the significant moments of training on the screen and raising alerts in case of an error.

19. The method for Airway Management training for healthcare professionals as claimed in claim 14, wherein the Artificial Intelligence module summarizes the session performance and provides debriefing insights to trainee practitioners, along with personalized recommendations for improvement based on being trained on the data of past training sessions with a clear labelling of the sessions in five categories-very good, good, OK, bad and very bad.

20. The method for Airway Management training for healthcare professionals as claimed in claim 14, wherein based on the neural network training that involves a large set of clearly labeled session data, an inference module is produced and this inference module is then used to classify any new training session belonging to the above categories, based on the model weightage and the statistics of the current session compared to the past ones, whereby the neural network not only produces the assessment of any new training session based on the five labelled outcomes, but also provides personalized recommendations based on the “explainable AI” features, said “explainable AI” functionality highlights those session events that have contributed maximum to negative outcomes during a training session, so that the trainee student can work on related actions for better outcomes.

21. The method as claimed in claim 14, wherein a deterministic module, an augmented reality module and an artificial intelligence module are hosted in a cloud-hosted platform that controls the entire operation and related activities like online registration of individual manikins, coordination of multiple training sessions, training session management, display of live training sessions, and replay of recorded trainings.

22. A method for Airway Management training for healthcare professionals applying the system as claimed in claim 1 comprising:
a) starting of the process by the practitioner by inserting an endo-tracheal tube fitted with a magnet inside the smart manikin, whereby its movement generates electro-magnetic flux in presence of sensors placed inside the manikin;
b) processing of the data generated by the sensors on detecting the movement of the magnetic-tipped endo-tracheal tube inside the manikin, along with the related temporal metadata by the manikin controller box and sending to the cloud, over the generic MQTT data-transfer protocol;
c) collecting of the data, by the sensors and staging in the backend cloud platform, followed by further processing by “Location Triangulation”, to determine the exact location of the magnetic tip inside the manikin, based on the magnitude of the sensor value and the time journey of the magnetic tip past other sensors that are nearby;
d) the most probable location of the magnetic tip of the end-tracheal tube, as processed by the proximity calculation program in the previous step, is rendered as a visual element on the graphic user interface of any display terminal that is connected to the cloud, accessible by world wide web;
e) detecting the potential location inside the manikin of the endo-tracheal tube as it passes the sensor points, in the back-end platform by the “location triangulation” module and an “Event Detection” module applies a rule engine to detect the significant moments during the movement of the tube;
f) a “co-sharing” module orchestrates the multiple inter-actions on different terminals (e.g., student and the remote instructor) in time-domain so that multiple viewership is enabled for the same procedure;
g) applying an automated assessment (debriefing) module which implements a discriminative neural network that is trained on the data generated by sensors during thousands of practice sessions and manually labelled into different classes (i.e., good, bad, excellent, or average) and there is a corresponding scoring scale attached to it, the higher score representing better quality of procedure wherein the fully trained neural network receives data the data for any new practice session for which the user wants an automated assessment (i.e., debriefing) and neural network classifies the session data (based on it prior training;
h) based on the assessment score generated by the automated assessment module, an adaptive cognitive testing module is kicked off from the Graphic User Interface of the practitioner wills, the pitfalls like “repeated digestive tract entry” that are identified previously feeds into a “prompt engineering algorithm” wherein the “prompt engineering algorithm” generates context-sensitive prompt, that is specific to the kind of errors made in the practice session; and
i) the metrics are collected during the entire process from intubation to adaptive cognitive testing and analyzed to feed into the process every few months, for process optimization.
